(19) United States
(12) Patent Application Publication
(10) Pub. No.: US 2002/0077974 A1
(43) Pub. Date: Jun. 20, 2002

(54) Wireless point of sale

(76) Inventor: Luis M. Ortiz, Dallas, TX (US)

Correspondence Address: Kermit D. Lopez, PO Box 7720, Dallas, TX, 75209-0720, US

(21) Appl. No.: 09/740,626

(22) Filed: Dec. 19, 2000

(51) Int. Cl. G06F 17/60

(52) U.S. Cl. 705/39

(57) ABSTRACT

A method and system for processing credit card data through a wireless hand held device. credit card data may be read from a credit card utilizing a credit card reader integrated with a wireless hand held device. The credit card holder is physically permitted to input an electronic signature through a touch screen display integrated with the wireless hand held device to authorize a credit card transaction associated with the credit card. The credit card data may be transferred from the wireless hand held device to a wireless network. A physical signature can be input via the touch screen display by a credit card holder is accepted and thereafter converted to an electronic signature. The electronic signature may be transferred from the wireless hand held device through a wireless network to a server. The electronic signature and the credit card data can be processed through the server, and the credit card transaction additionally stored at the server. A customer receipt may be rendered through local printing, electronic transfer and/or delivery to electronic mail accounts, or in accordance with a customer profile.

### BACKGROUND OF THE INVENTION

1. Technical Field of the Invention

The present invention is generally related to electronic hand held devices (hereinafter referred to as “hand held devices”) and wireless economic transactions thereof. The present invention is also related to hand held devices, such as a Personal Digital Assistant (PDA), wireless telephone, pager, or other mobile computing and storage device adapted for use in E-commerce. The present invention is also related to wireless and wired computer networks. The present invention is also related to the fields of electronic cash and credit transactions of retail establishments, organizations, and customers. The present invention is also related generally to merchandising systems and methods for rendering customer receipts.

2. Description of the Related Art

The recent shift in the consumer electronics industry from an emphasis on analog technology to a preference for digital technology is largely based on the fact that the former generally limits the user to a role of a passive recipient of information, while the latter is interactive and allows the user to control what, when, and how he or she receives and manipulates certain information.

This shift in focus has resulted in the development and increasingly widespread use of, for example, a hand held digital device generically referred to as a “personal digital assistant” (PDA). These hand held devices are becoming increasingly popular for storing and maintaining information. Hand held devices, such as PDAs, may be connected to a desktop personal computer, networks or other PDAs via infrared, direct wire, or wireless communication links.

Unlike personal computers, which are general-purpose devices geared toward refining and processing information, PDAs are designed to capture, store and display information originating from various sources. Additionally, while a certain level of skill is required to use a personal computer effectively, hand held devices, such as PDAs, are designed with the novice and non-computer user in mind.

A typical PDA includes a microprocessor, a memory unit, a display, associated encoder circuitry, and selector buttons. It may optionally contain a clock and infrared emitter and receiver. A graphical user interface permits a user to store, retrieve and manipulate data via an interactive display. A PDA also typically includes a calendar, datebook, and one or more directories. The calendar shows a month of dates organized as rows and columns in the usual form. The datebook shows one day at a time and contains alphanumeric text entered in free format (typically, with a time of day and an event and/or name). Each directory contains entries consisting of a name field and a free form alphanumeric text field that can contain company names, addresses, telephone and fax numbers, email addresses, etc.

Entries may be organized alphabetically according to the name field and can be scanned or searched for by specifying a specific sequence of characters in the name field. A menu displayed via the graphical user interface permits a user to choose particular functions and directories. Most PDAs come equipped with a stylus, which is a plastic-tipped pen that a user utilizes to write in a “graffiti area” of the display and tap particular graphically displayed icons. Each icon is indicative of a particular activity or function.

PDAs are increasingly being utilized to access information from remote computer networks, such as the “World Wide Web” and the “Internet,” both terms well known in the computer networking arts. PDA users can, for example, download e-mail from the Internet to the PDA. Web sites also exist, which permit PDA users to access and download software that may be run on the PDA. For example, some web sites offer information to PDAs in the form of compressed news articles, stock quotes, and other data obtained from a wide variety of other electronic web-based sources.

Based on the foregoing, it can be appreciated that a large number of users of hand held devices, such as PDAS, pagers and mobile telephony are increasingly relying on such devices to maintain and transmit a variety of personal and business information.

A typical credit card transaction begins when a customer hands a credit card to an establishment employee at a point of sale. Depending on the system utilized by the establishment, several options are typically available for customers and check out representatives. The establishment representative can either manually imprint the card onto a paper draft, if older technology is utilized, or the customer or employee can swipe the card through an electronic terminal, if new technology is utilized.

If the transaction is handled over the telephone or through the mail, the customer provides a credit card number. In these cases, the customer can either fill out a paper draft or key in the number at a terminal integrated with the point of sale.

The next step in the typical credit card transaction involves obtaining permission from the credit card company to process the sale with the credit card. Older technology typically requires employees to call a special number to obtain an authorization code Typically, this is only required with sales above a particular amount. If newer technology is being utilized, the authorization code can be obtained automatically. Once the authority has been obtained, the only remaining step to follow with the customer is to obtain the signature on the receipt. Communication between the credit card authorization agent or company and the point of sale (i.e., establishment) can take place through public telephone networks (e.g., PSTN).

The credit card sales receipts are then sent to the bank so that the establishment at which the credit card transaction took place can be paid. If older technology is relied upon, the receipts must be physically taken to a bank. If newer technology is utilized, the receipts can be sent electronically. This process usually occurs at the end of the day and is referred to as “settling” the accounts.

The bank authorizes the charge and notify the credit card company (or some company acting on its behalf) of the charge. The credit card company (or the company acting on its behalf) will collect the money from the bank that issued the card, send it to the bank, and bill the customer. Once the bank has the money, it will put it in an account of the establishment at which the credit card transaction originally took place, minus a processing fee, called the discount rate, which is split between the bank and the credit card company. When the customer pays the bill, the credit card company sends the money to the bank that issued the card, minus a processing fee.

One of the many problems faced by credit card holders, credit card companies, and enterprises or establishments that rely on credit cards is the inefficiency associated with maintaining credit card processing devices at wired point of sale locations. The inventors of the present invention believe that the ability to free a point of sale from a wired location can increase mobility and efficiency for establishments, credit card holders and credit card companies. The present invention described herein solves this and other limitations associated with wired point of sale credit card processing devices.

### SUMMARY OF THE INVENTION

It is an aspect of the present invention to provide improved methods and systems for conducting economic transactions utilizing hand held devices.

It is another aspect of the present invention to provide improved methods and systems for enabling wireless economic transactions through wireless hand held devices.

It is yet another aspect of the present invention to provide improved methods and systems for processing credit card data through wireless electronic hand held devices.

It is still another aspect of the present invention to provide for a wireless point of sale.

It is yet an additional aspect of the present invention to provide methods and systems for permitting credit card holders to input electronic signatures associated with credit card transactions.

Methods and systems for processing credit card data through a wireless hand held device are disclosed herein. According to the methods and systems discussed herein, credit card data may be read from a credit card utilizing a credit card or smart card reader integrated with a wireless hand held device. The credit card holding customer can be physically permitted to input an electronic signature through a touch screen display integrated with the wireless hand held device prior to, or for the purpose of, authorizing a credit card transaction associated with the credit card. The credit card data may be transferred from the wireless hand held device to a wireless network.

A physical signature can be input via the touch screen display by a credit card holder (i.e., customer) where it may be accepted and thereafter converted to an electronic signature. The electronic signature may be transferred from the wireless hand held device through a wireless network to a server. The electronic signature and the credit card data may be authenticated through the server, and the credit card transaction additionally stored at the server.

The electronic signature and transaction-related data may be rendered as a facsimile of a physical signature associated with the electronic signature and credit card transaction data at a printing station associated with the wireless network. The credit card transaction data and the electronic signature may also be rendered as a digitized representation of a physical signature to an electronic mailbox associated with the credit card holder. Also an electronic receipt may be rendered in an electronic medium selected by the credit card holder, wherein the electronic receipt verifies the credit card transaction. The electronic receipt may also be rendered in an electronic medium selected by the credit card holder, wherein, the electronic receipt verifies the credit card transaction and wherein the rendering may be further based on a credit card holder's profile. The electronic receipt can be transferred to a user e-mail account associated with the credit card.

Additionally, the electronic receipt and associated credit card data can be authorized through an authorization server associated with the wireless network. The electronic signature and/or the credit card data can be authorized through a credit card authorization server associated with a wireless network. An electronic record of the credit card transaction can be transferred to a wireless printer from the wireless hand held device through wireless communications. Finally, an electronic record of the credit card transaction may be transferred to a wireless hand held device associated with the credit card holder through device-based wireless communications, such as, for example, infrared (IR) or radio frequency (RF).

### BRIEF DESCRIPTION OF THE DRAWINGS

The novel features believed characteristic of this invention are set forth in the appended claims. The invention itself, however, as well as a preferred mode of use, further objects, and advantages thereof, will best be understood by reference to the following detailed description of an illustrative embodiment when read in conjunction with the accompanying drawings, wherein:

FIG. 1 depicts a schematic diagram generally illustrating a hardware configuration of a hand held device usable in accordance with preferred embodiments of the present invention;

FIG. 2 illustrates a pictorial diagram illustrating a hand held device, which may be utilized in accordance with preferred embodiments of the present invention;

FIG. 3 depicts an alternative pictorial diagram illustrating a hand held device, which may be utilized in accordance with preferred embodiments of the present invention;

FIG. 4 illustrates a block diagram illustrating a system for processing credit card transactions through a wireless hand held device, in accordance with preferred embodiments of the present invention;

FIG. 5 depicts a detailed block diagram illustrating a system for processing credit card transactions through a wireless hand held device, in accordance with preferred embodiments of the present invention;

FIG. 6 illustrates data transfer between hand held devices, in accordance with preferred embodiments of the present invention;

FIG. 7 depicts a system for rendering credit card receipts electronically, in accordance with preferred embodiments of the present invention;

FIG. 8 illustrates an entity diagram illustrating possible attributes for a wireless network, which may be utilized in accordance with preferred embodiments of the present invention; and

FIG. 9 depicts a flow chart of operations for processing credit card transactions through a wireless hand held device, in accordance with preferred embodiments of the present invention.

### DETAILED DESCRIPTION OF PREFERRED EMBODIMENTS

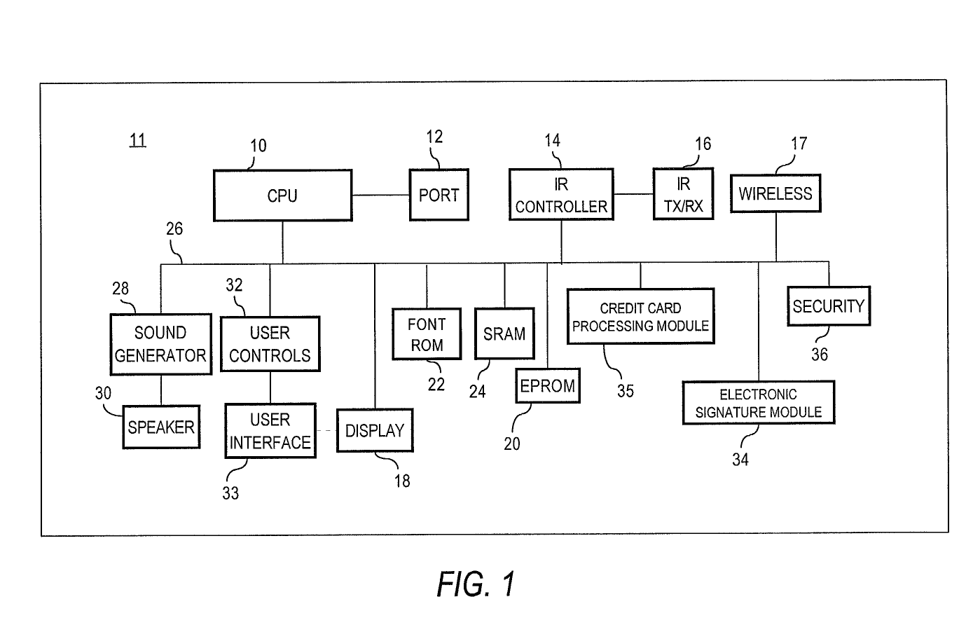

FIG. 1 depicts a schematic diagram illustrating a general hardware configuration of a hand held device 11 usable in accordance with an embodiment of the present invention. Those skilled in the art can appreciate, however, that other hardware configurations may be utilized, and are further described herein, to implement hand held device 11. CPU 10 of hand held device 11, acts as a main controller operating under the control of operating clocks supplied from a clock oscillator (OSC) 13. CPU 10 may be configured as a 16-bit microprocessor. External pins of CPU 10 are generally coupled to an internal bus 26 so that it may be interconnected to respective components via internal bus 26.

A SRAM 24 that may be used in hand held device 11 can be configured as a writeable memory that does not require a refresh operation and which is generally utilized as a working area of CPU 10. SRAM (Static RAM) is generally a form of semiconductor memory (RAM) based on a logic circuit known as a flip-flop, which retains information as long as there is enough power to run the device. Font ROM 22 that may be used in hand held device 11 can be configured as a read only memory for storing character images (e.g., font) displayable on a liquid crystal (LCD) panel 18.

CPU 10 of the present embodiment drives LCD display 18 utilizing, among other media, font images from Font ROM 22. An EPROM 20 may be configured as a read only memory that is generally erasable under certain conditions and can be utilized for permanently storing control codes for operating respective hardware components and security data, such as a serial number. Those skilled in the art can appreciate that EPROM 20 and Font ROM 22 represent merely one type of memory devices that may be utilized in accordance with hand held device 11. Other memory devices may also be utilized to implement hand held device 11 and are well known in the art.

IR controller 14 can be generally configured as a dedicated controller for processing an infrared code transmitted/received by an IR transceiver 16 and for capturing the same as computer data. Wireless module 17 can generally be configured as a dedicated controller and transceiver for processing wireless RF data transmitted from and to a wireless communications network.

Port 12 can be connected to CPU 10 and can be temporarily attached, for example, to a docking station to transmit information to and from hand held device 11 to other devices, such as personal computers, retail cash registers, electronic kiosk devices, and so forth. Port 12 can also be configured, for example, to link with a modem, cradle or docking station, which are well known in the art, and that permit network devices, a personal computer or other computing devices to communicate with hand held device 11.

User controls 32 may further permit a user to enter data to hand held device 11 and initiate particular processing operations via CPU 10. In addition, CPU 10 may cause a sound generator 28 to generate sounds of predetermined frequencies from a speaker 30. User interface 33 may be configured as a touch screen user interface. User interface 33 is linked to user controls 32 and may be integrated with display 18. Thus, user interface 33 and display 18 may be combined to form a touch screen user interface which permits a user to input data to hand held device 11.

Those skilled in the art appreciate that a touch screen display is a type of computer display screen designed or modified to recognize the location of a touch on its surface. By touching the screen or display, the user can make a selection. The simplest type of touch screen, which may be utilized in accordance with the present invention, can be composed of a grid of sensing lines, which determine the location of a touch by matching vertical and horizontal contacts. Another, more accurate type of touch screen display that can be implemented in accordance with hand held device 11 may utilize an electrically charged surface and sensors around the outer edge of the screen to detect the amount of electrical disruption and pinpoint exactly where contact has been made. Typical touch screens that can be utilized in accordance with hand held device 11 includes those types of touch screen displays utilized in many of the Palm Pilot family of PDA devices.

Additionally, a credit card processing module 35 may be integrated with hand held device 11 through system bus 26. Credit card processing module 35 may include a credit card reader for reading credit cards (e.g., magnetic or chip-enabled smart cards). The credit card reader can be integrated with the hand held device, as indicated in FIG. 3. Credit card processing module 35 may also include a variety of software modules, which permit credit card data to be retrieved from a credit card via the card reader.

Software modules may be composed of routines, subroutines and data structures that perform a particular task or implements a particular abstract data type. Software modules usually include two parts: an interface, which lists the constants, data types, variables, and routines and sub-routines that can be accessed by other modules or routines/subroutines, and an implementation, which is private (accessible only to the software module) and which contains the source code that actually implements the routines in the module. The term “module” can also refer to a self-contained component that can provide a complete function to a system and can be interchanged with other modules that provide similar features.

Card readers may be fixably integrated with hand held device 11, or may be configured as hardware modules that are plugable into a port or slot of the hand held device. An example of such module/cartridge configurations can be found in the Handspring Visor™ devices currently available in the marketplace. “Handspring Visor” is a trademark of Handspring, Inc. located in Mountain View, Calif. Thus, credit card processing module 35 may be configured as physical module that for reading credit cards or a software module for performing particular processing functions, such as reading and processing credit card data, or a combination thereof.

Wireless module 17 can be configured as a physical module (e.g., a cartridge, integrated circuit component, etc.), a software module (e.g., computer program) or a combination thereof for permitting hand held device 11 to communicate with a wireless network, such as cellular-type wireless networks, which are discussed in greater detail herein. Wireless module 17 can thus be configured to provide wireless data connections over wireless networks. A security module 36 can be configured with hand held device 11 to provide data security protection for data transmitted to and from hand held device through wired and/or wireless communications means. Such a security module can be implemented as a physical module, as described above, or a software module, or a combination thereof, for providing data security capabilities, such as automatic encryption/decryption to hand held device 11.

Additionally, an electronic signature module 34 can be integrated with hand held device 11 through system bus 26. Such an electronic signature module can be implemented as a physical module and/or a software module. Electronic signature module 36 permits a credit card holder to physical input an electronic signature through a touch screen display integrated with hand held device 11 to authorize a credit card transaction associated with the credit card. Electronic signature module 36 thus permits a physical signature of a credit card holder input via the touch screen display by the credit holder to be accepted and converted to an electronic signature. The electronic signature can be then transferred from the hand held device through a wireless network to a server for authentication, along with credit card data read from a credit card by the hand held device. The electronic signature is transmitted from hand held device 11 through wireless module 17 to a wireless network.

Those skilled in the art can appreciate that additional electronic circuits or the like other than, or less, or in addition to, those illustrated in FIG. 1 may be required to construct hand held device 11. Such components, however, are not described in the present specification, because they are well known in the art. Those skilled in the art can thus appreciate that because of the brevity of the drawings described herein, only a portion of the connections between the illustrated hardware blocks is generally depicted. In addition, those skilled in the art will appreciate that hand held device 11 can be implemented as a specific type of a hand held device, such as a Personal Digital Assistant (PDA), paging device, WAP-enabled mobile phone, electronic tablet, and other associated hand held computing devices well known in the art.

When PDAs are deployed, such PDA devices can be further configured with both wireless and wireline communications capabilities, such as those found in cellular telephone units, in accordance with carrying out embodiments of the present invention. Examples of PDA devices that can be utilized in accordance with the method and system of the present invention include the “PalmPilot” PDA, manufactured and sold by Palm Computing, the Handspring Visor, the IBM Workpad, WINDOW CE compatible devices, RIM Blackberry-family paging devices, Motorola paging devices, and the Symbol SPT-family of PDA-type organizer devices. Hand held devices may be also configured with optical scanning/capturing capabilities, in accordance with embodiments of the present invention, which will be further described below.

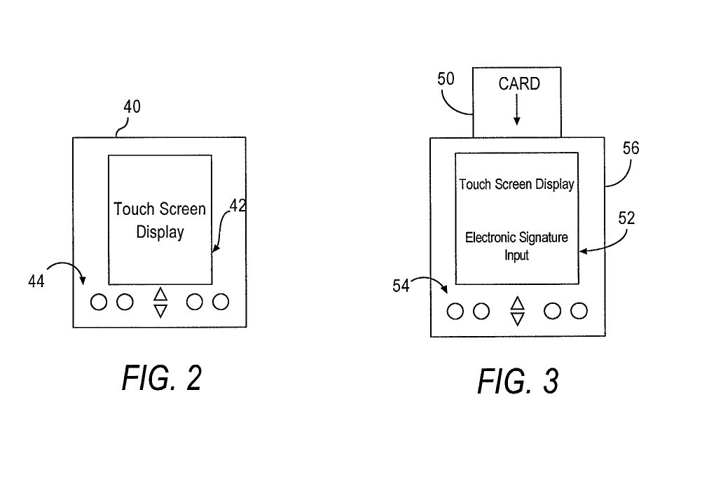

FIG. 2 illustrates a pictorial diagram of a hand held device that may be utilized in accordance with preferred embodiments of the present invention. Those skilled in the art will appreciate that hand held device 40 of FIG. 2 is analogous to hand held device 11 of FIG. 1. Hand held device 40 includes a display screen 42, which is generally analogous to display 18 of FIG. 1.

Hand held device 40 may be configured as a “Palm Pilot” or other similar PDA devices. User controls 44 permit a user to manipulate images or text displayed on display screen 42. User controls 44 of FIG. 2 are generally analogous to user controls 32 of FIG. 1. A touch screen user interface may be further configured on display screen 42 with hand held device 40 to permit a user to manipulate images/text displayed on display screen 42.

FIG. 3 depicts a pictorial representation of a hand held device 56 adapted for receiving a module 50, in accordance with preferred embodiments of the present invention. Hand held device 56 of FIG. 3 is generally analogous to hand held device 40 of FIG. 2, the difference being that hand held device 56 may be adapted to receive a module/cartridge that permits hand held device 56 to function according to specific hardware and/or instructions contained in a memory location within module 50. Module 50 may be configured as a cartridge, credit card, or smart card. A smart card may provide, for example, access codes (e.g., decryption) to enable hand held device 56 to receive venue broadcasts.

Note that as utilized herein, the term “module” may refer to a physical module, such as a cartridge. The term “module” may also refer to a software module composed of routines or subroutines that perform a particular function. Those skilled in the art can appreciate the meaning of the term module is based on the context in which the term is utilized. Thus, module 50 may be generally configured as a physical cartridge is or smart card. The term “module” as utilized herein may also refer to a software module, depending on the context of the discussion thereof.

To illustrate the use of a physical module, such as module 50, assume that a user may possess several such physical modules or cartridges. One module, when inserted into a hand held device may permit the hand held device to function as a standard PDA, such as a Palm Pilot device.

Those skilled in the art can thus appreciate that hand held device 56 can be adapted to receive and cooperate with module 50. Module 50 may also be configured as a standard credit card or smart card. Additionally, hand held device 56 includes a display screen 52 that is generally analogous to display screen 42 of FIG. 2 and display 18 of FIG. 1. Display screen 52 may be configured as a touch screen display having an area for inputting an electronic signature converted from a physical signature.

Hand held device 56 can be configured to physically permit a credit card holder to input an electronic signature through the touch screen display integrated with display screen 52 in order to authorize a credit card transaction associated with the credit card, smart card or module (i.e., module 50). Hand held device 56 may also include user controls 54 that are generally analogous to user controls 44 of FIG. 2 and user controls 32 of FIG. 1. Hand held device 56 of FIG. 3 is thus generally analogous to hand held device 11 of FIG. 1. Hand held device 56 implement touch screen capabilities through a touch screen user interface integrated with display screen 52.

As indicated above, module 50 may be implemented as a chip-enabled smart card, instead of a magnetic strip cartridge or standard credit card. It is anticipated that similar features can be implemented in accordance wit the smart card to insure that hand held device 56 includes touch screen user interface and video viewing capabilities. Smart cards are generally known in the art as credit-card sized plastic cards with an embedded computer chip. The chip can either be a microprocessor with internal memory or a memory chip with non-programmable logic. The chip connection can be configured via direct physical contact or remotely through a contactless electromagnetic interface.

Smart cards may be generally configured as either a contact or contactless smart card, or a combination thereof. A contact smart card requires insertion into a smart card reader (e.g., contained within hand held device 56) with a direct connection to, for example, a conductive micromodule on the surface of the card. Such a micromodule may be generally gold plated. Transmission of commands, data, and card status takes place through such physical contact points. Note that the word “micromodule” can be distinguished from the phrase word “module” utilized above.

A contactless card (i.e., in the non-electrical sense) generally requires only close proximity to a reader. Both the reader and the card may be implemented with antenna means providing a contactless link that permits the devices to communicate with one another. Contactless cards can also maintain internal chip power or an electromagnetic signal (e.g., RF tagging technology). Two additional categories of smart codes, well known in the art, which are based on contact and contactless cards are the so-called Combi cards and Hybrid cards.

A Hybrid card generally may be equipped with two chips, each with a respective contact and contactless interface. The two chips are not connected, but for many applications, this Hybrid serves the needs of consumers and card issuers. The Combi card may be generally based on a single chip and can be generally configured with both a contact and contactless interface.

Chips utilized in such smart cards are generally based on microprocessor chips or memory chips. Smart cards based on memory chips depend on the security of the card reader for their processing and can be utilized when low to medium security requirements. A microprocessor chip can add, delete and otherwise manipulate information in its memory. Microprocessor-based memory cards typically contain microprocessor chips with 8, 16, and 32 bit architectures.

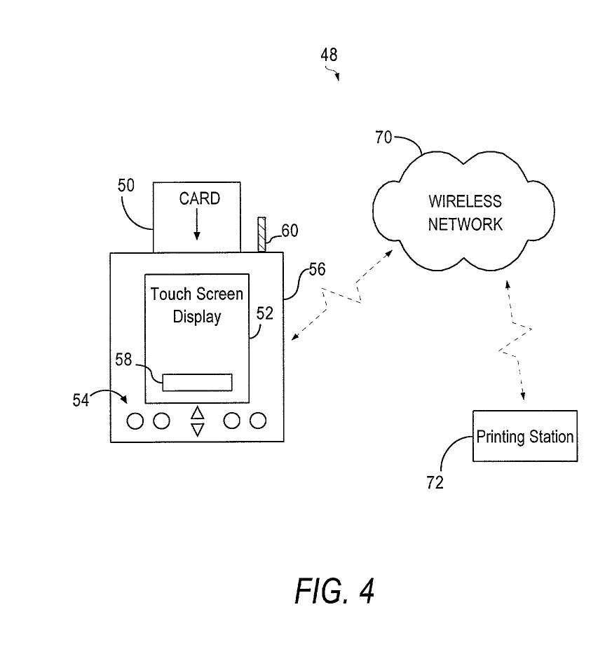

FIG. 4 illustrates a block diagram 48 illustrating a system for processing credit card transactions through a wireless hand held device 56, in accordance with preferred embodiments of the present invention. Note that in FIGS. 4-6, like parts are indicated by like reference numerals. Thus, hand held device 56 of FIGS. 4-7 is analogous to hand held device 56 of FIG. 3, which in turn is analogous to hand held device 11 of FIG. 1. Hand held device 42 of FIG. 2 can simply be a variation of hand held device 56.

As indicated in FIG. 4, hand held device 56 would probably be configured with touch screen display 52. Touch screen display 52 may include a signature area 58, wherein a credit card holder may physically input an electronic signature through touch screen display 52 to authorize a credit card transaction associated with the credit card. An electronic signature module, such as electronic signature module 34 of FIG. 1 may be utilized in accordance with hand held device 56 to permit a user to input an electronic signature to authorize credit card transactions.

Electronic signature module 34 may be implemented as a physical module, integrated circuit component, software module, or combination thereof. As explained previously, module 50 may be implemented as a credit card or a smart card. Credit card data may be read from the credit card (i.e., module 50) utilizing a credit card reader integrated with hand held device 56. Note that credit card processing module 35 of FIG. 1 can be utilized in accordance with hand held device 56 to perform credit card reading operations.

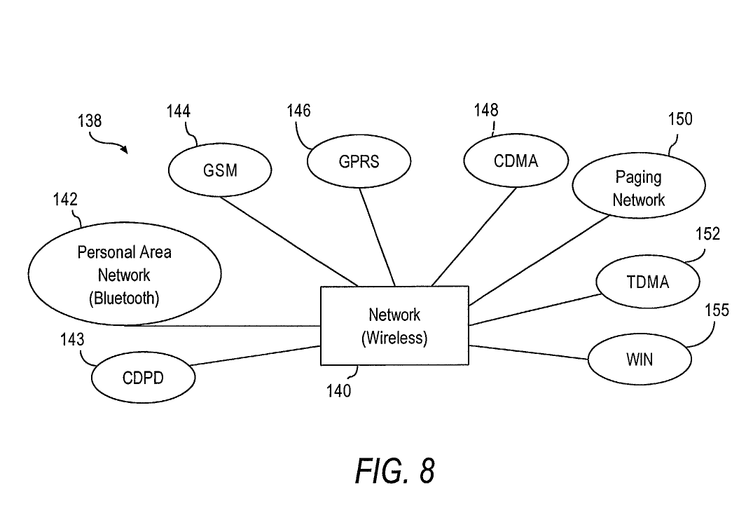

Thus, hand held device 56 permits a physical signature input via touch screen display 52 by a credit card holder to be accepted by hand held device 56 and converted to an electronic signature. Hand held device 56 may also be configured with an antenna 60 which permits hand held device 56 to communicate with a wireless network 70 utilizing a wireless module, such as wireless module 17 of FIG. 1. A receipt associated with the credit card transaction may then be rendered at a printing station 72 through wireless network 70. Note that various types of potential wireless networks that may be utilized in accordance with the present invention are illustrated in FIG. 8 herein.

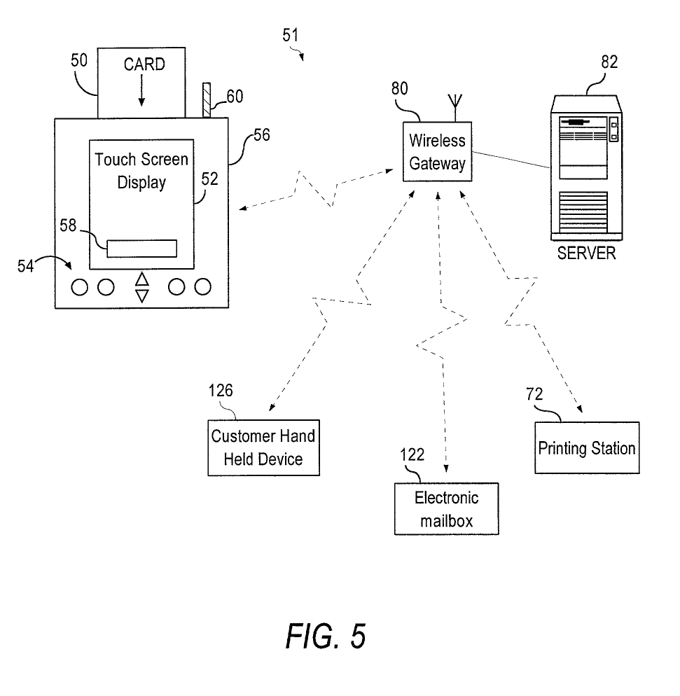

FIG. 5 depicts a detailed block diagram illustrating a system for processing credit card transactions through a wireless hand held device, in accordance with preferred embodiments of the present invention. Note that in FIGS. 4-5, like parts are indicated by like reference numerals. Thus, as indicated in FIG. 5, wireless hand held device 56 may communicate with a wireless gateway 80 that is linked to or integrated with a server 82. Server 82 is a computing management and storage device that can be implemented within a Wireless Local Area Network (WLAN).

Server 82 may run administrative software that controls access to the WLAN and its resources, such as printers, and disk drives, and provides resources to computers and/or wireless devices functioning as workstations or other wireless hand held devices within the WLAN. Server 82 may also be configured as a computer or program that responds to commands from a client within a client/server based network with wireless capabilities. Potential resources that may be available within a WLAN associated with server 82 include a printing station 72, an electronic mailbox 122, and a customer hand held device 126.

Customer hand held device 126 may simply be, for example, a wireless PDA that can communicate with the WLAN either directly or through an associated cellular or other type of wireless network, such as the wireless networks described herein relative to FIG. 8. Electronic mailbox 122 may simply be a customer e-mail account. Rather than print out a receipt at printing station 72, an electronic receipt may be transmitted to a customer e-mail account. Those skilled in the art can thus appreciate based on the foregoing that hand held device 56, when utilized in accordance with the methods and systems described herein, may constitute a wireless point of sale wherein credit card transactions re processed.

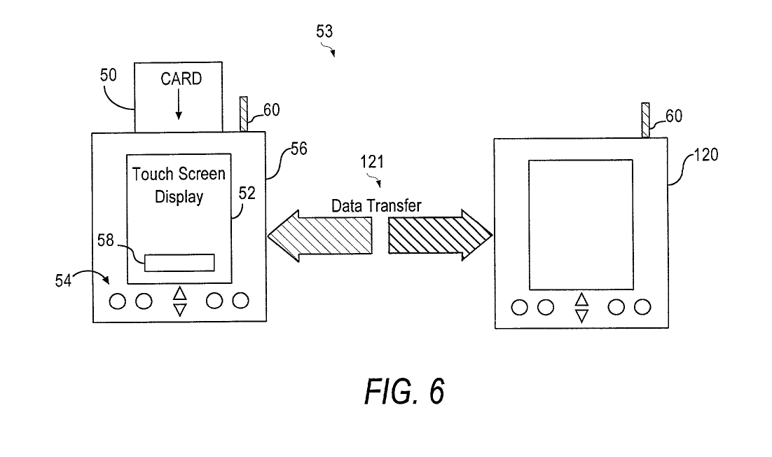

FIG. 6 illustrates a block diagram 53 illustrating data transfer between hand held devices, in accordance with preferred embodiments of the present invention. Hand held device 56 of FIG. 6 is analogous to hand held device 56 of FIG. 1-5. Hand held device 120 of FIG. 6 represents a customer hand held device, such as customer hand held device 126 of FIG. 5, or another hand held device. According to block diagram 53, data may be transferred between a wireless point of sale (i.e., hand held device 56) operated by an enterprise or establishment, and a hand held device 120. The data may be transferred via wireless communications means (e.g., infrared or radio frequency) or direct wired data transfer. Hand held device 56 may be, configured with credit card reading and electronic-signature capturing capabilities.

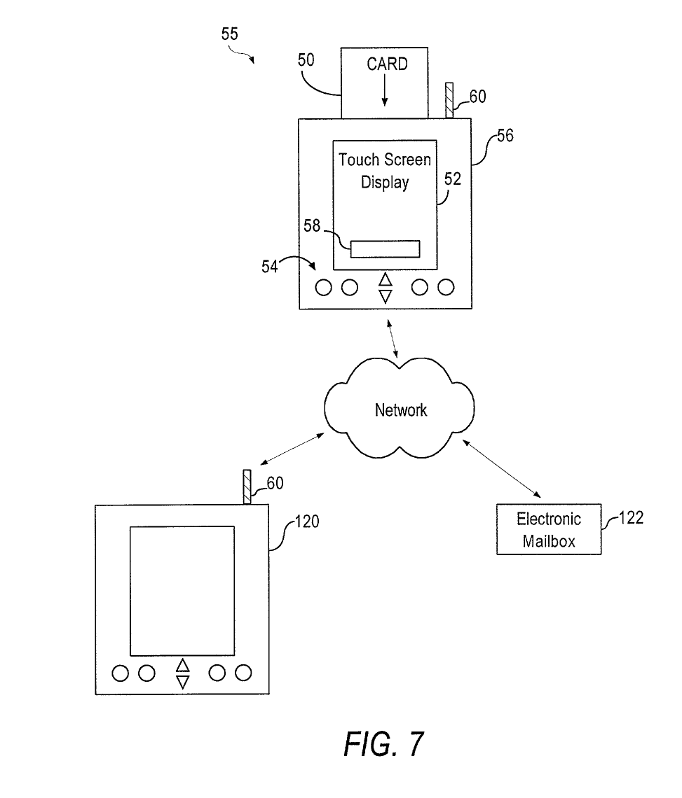

FIG. 7 depicts a system 55 for rendering credit card receipts electronically, in accordance with preferred embodiments of the present invention. In FIGS. 5-7, like parts are indicated by like reference numerals. Thus, wireless hand held device 56 (i.e., wireless point of sale) can transmit data to another hand held device 120 or electronic mailbox 122 through a network 130. Network 130 may be configured as a wired or wireless network or a combination thereof.

FIG. 8 illustrates an entity diagram 138 illustrating possible attributes for a wireless network 140, which may be utilized in accordance with preferred embodiments of the present invention. Wireless network 140 of FIG. 8 is analogous to wireless network 70 of FIG. 4 and/or wireless network 140 as illustrated in FIG. 8 can be configured as a variety of possible wireless networks. Thus, entity diagram 138 illustrates attributes of wireless network 140, which may or may not be exclusive of one another.

Those skilled in the art can appreciate that a variety of possible wireless communications and networking configurations may be utilized to implement wireless network 140. Wireless network 140 may be, for example, implemented according to a variety of wireless protocols, including cellular, Bluetooth, and other RF or direct IR data communications. Wireless network 140 can be implemented as a single network type (e.g., Bluetooth) or a network based on a combination of network types (e.g., GSM, CDMA, etc).

Wireless network 140 may be configured with teachings/aspects of CDPD (Cellular Digital Packet Data) networks well known in the networking arts. CDPD network 143 is illustrated in FIG. 8. CDPD may be configured as a TCP/IP based technology that supports Point-to-Point (PPP) or Serial Line Internet Protocol (SLIP) wireless connections to mobile devices, such as the hand held devices described and illustrated herein. Wireless service is generally available throughout the world from major service providers. Data can be transferred utilizing CDPD protocols.

Current restrictions of CDPD are not meant to limit the range or implementation of the method and system described herein, but are described herein for illustrative purposes only. It is anticipated that CDPD will be continually developed, and that such new developments can be implemented in accordance with the present invention.

Wireless network 140 may preferably be also configured with teachings/aspects of a Personal Area Network 142 or Bluetooth, as described herein. Bluetooth was adopted by a consortium of wireless equipment manufacturers referred to at the Bluetooth Special Interest Group (BSIG), and has emerged as a global standard for low cost wireless data and voice communication. Current specifications for this standard call for a 2.4 GHz ISM frequency band. Bluetooth technology is generally based on a short-range radio transmitter/receiver built into small application specific circuits (ASICS, DSPs) and embedded into support devices, such as the hand held devices described and illustrated herein.

The Bluetooth standard permits up to 100 mw of power, which can increase the range to 100 M. In addition, Bluetooth can support several data channels. Utilizing short data packets and frequency hopping of up to 1600 hops per second, Bluetooth is a wireless technology that can be utilized to enable the implementation of the methods and systems described herein. Current restrictions of Bluetooth are not meant to limit the range or implementation of the present invention, but are described herein for illustrative purposes only. It is anticipated Bluetooth will be continually developed, and that such new developments can be implemented in accordance with the present invention.

Wireless network 140 may also be configured utilizing teachings/aspects of GSM network 144. GSM (Global System for Mobile Communication) and PCS (Personal Communications Systems) networks, both well known in the telecommunications arts, generally operate in the 800 MHz, 900 MHz, and 1900 MHz range. PCS initiates narrowband digital communications in the 900 MHz range for paging, and broadband digital communications in the 1900 MHz band for cellular telephone service. In the United States, PCS 1900 is generally equivalent to GSM 1900. GSM operates in the 900 MHz, 1800-1900 MHz frequency bands, while GSM 1800 is widely utilized throughout Europe and many other parts of the world.

In the United States, GSM 1900 is generally equivalent to PCS 1900, thereby enabling the compatibility of these two types of networks. Current restrictions of GSM and PCS are not meant to limit the range or implementation of the present invention, but are described herein for illustrative purposes only. It is anticipated that GSM and PCS will be continually developed, and that aspects of such new developments can be implemented in accordance with the present invention.

Wireless network 140 may also utilize teachings/aspects of GPRS network 146. GPRS technology, well-known in the telecommunications arts, bridges the gap between current wireless technologies and the so-called “next generation” of wireless technologies referred to frequently as the third-generation or 3G wireless technologies. GPRS is generally implemented as a packet-data transmission network that can provide data transfer rates up to 115 Kbps. GPRS can be implemented with CDMA and TDMA technology and supports X.25 and IP communications protocols, all well known in the telecommunications arts. GPRS also enables features, such as Voice over IP (VIP) and multimedia services. Current restrictions of GPRS are not meant to limit the range or implementation of the present invention, but are described herein for illustrative purposes only. It is anticipated that GPRS will be continually developed and that such new developments can be implemented in accordance with the present invention.

Wireless network 140 may also be implemented utilizing teaching/aspects of a CDMA network 148 or CDMA networks. CDMA (Code Division Multiple Access) is a protocol standard based on IS-95 CDMA, also referred to frequently in the telecommunications arts as CDMA-1. IS-95 CDMA is generally configured as a digital wireless network that defines how a single channel can be segmented into multiple channels utilizing a pseudo-random signal (or code) to identify information associated with each user. Because CDMA networks spread each call over more than 4.4 trillion channels across the entire frequency band, it is much more immune to interference than most other wireless networks and generally can support more users per channel.

Currently, CDMA can support data at speeds up to 14.4 Kbps. Wireless network 140 may also be configured with a form of CDMA technology known as wideband CDMA (W-CDMA). Wideband CDMA may be also referred to as CDMA 2000 in North America. W-CDMA can be utilized to increase transfer rates utilizing multiple 1.25 MHz cellular channels. Current restrictions of CDMA and WCDMA are not meant to limit the range or implementation of the present invention, but are described herein for illustrative purposes only. It is anticipated that CDMA and W-CDMA will be continually developed and that such new developments can be implemented in accordance with the present invention.

Wireless network 140 may be also implemented utilizing teachings/aspects of paging network 150. Such paging networks, well known in the telecommunications arts, can be implemented in accordance with the present invention to enable transmission or receipt of data over the TME/X protocol, also well known in the telecommunications arts. Such a protocol enables notification in messaging and two-way data coverage utilizing satellite technology and a network of base stations geographically located throughout a particular geographical region. Paging network 150 can be configured to process enhanced 2-way messaging applications.

Unified messaging solutions can be utilized in accordance with wireless network 140 to permit carriers and Internet service providers to manage customer email, voice messages and fax images and can facilitate delivery of these communications to PDAs, telephony devices, pagers, personal computers and other capable information retrieval devices, wired or wireless.

Current restrictions of such paging networks are not meant to limit the range or implementation of the present invention, but are described herein for illustrative purposes only. It is anticipated that such paging networks, including those based on the TME/X protocol, will be continually developed and that such new developments can be implemented in accordance with the present invention.

Wireless network 140 may also be configured utilizing teachings/aspects of TDMA networks 152. TDMA (Time Division Multiple Access) is a telecommunications network utilized to separate multiple conversation transmissions over a finite frequency allocation of through-the-air bandwidth. TDMA can be utilized in accordance with the present invention to allocate a discrete amount of frequency bandwidth to each user in a TDMA network to permit many simultaneous conversations or transmission of data. Each user may be assigned a specific timeslot for transmission. A digital cellular communications system that utilizes TDMA typically assigns ten timeslots for each frequency channel.

A hand held device operating in association with a TDMA network sends bursts or packets of information during each timeslot. Such packets of information are then reassembled by the receiving equipment into the original voice or data/information components. Current restrictions of such TDMA networks are not meant to limit the range or implementation of the present invention, but are described herein for illustrative purposes only. It is anticipated that TDMA networks will be continually developed and that such new developments can be implemented in accordance with the present invention.

Wireless network 140 may also be configured utilizing teachings/aspects of Wireless Intelligent Networks (WINs) 155. WINs are generally known as the architecture of the wireless switched network that allows carriers to provide enhanced and customized services for mobile telephones. Intelligent wireless networks generally include the use of mobile switching centers (MSCs) having access to network servers and databases such as Home Location Registers (HLRs) and Visiting Location Registers (VLRs), for providing applications and data to networks, service providers and service subscribers (wireless device users).

Local number portability allows wireless subscribers to make and receive calls anywhere—regardless of their local calling area. Roaming subscribers are also able to receive more services, such as call waiting, three-way calling and call forwarding. A HLR is generally a database that contains semipermanent mobile subscriber (wireless device user) information for wireless carriers' entire subscriber base.

A useful aspect of WINs for the present invention is enabling the maintenance and use of customer profiles within an HLR/VLR-type database. Profile information may be utilized for example with season ticket holders and/or fans of traveling teams or shows. HLR subscriber information as used in WINs includes identity, service subscription information, location information (the identity of the currently serving VLR to enable routing of communications), service restrictions and supplementary services/information. HLRs handle SS7 transactions in cooperation with Mobile Switching Centers and VLR nodes, which request information from the HLR or update the information contained within the HLR. The HLR also initiates transactions with VLRs to complete incoming calls and update subscriber data. Traditional wireless network design is generally based on the utilization of a single HLR for each wireless network, but growth considerations are prompting carriers to consider multiple HLR topologies.

The VLR may be also configured as a database that contains temporary information concerning the mobile subscribers currently located in a given MSC serving area, but whose HLR may be elsewhere. When a mobile subscriber roams away from the HLR location into a remote location, SS7 messages are used to obtain information about the subscriber from the HLR, and to create a temporary record for the subscriber in the VLR.

Signaling System No. 7 (referred to as SS7 or C7) is a global standard for telecommunications. In the past the SS7 standard has defined the procedures and protocol by which network elements in the public switched telephone network (PSTN) exchange information over a digital signaling network to effect wireless and wireline call setup, routing, control, services, enhanced features and secure communications. Such systems and standards may be utilized to implement wireless network 140 in support of venue customers, in accordance with the present invention.

Improved operating systems and protocols allow Graphical User Interfaces (GUIs) to provide an environment that displays user options (e.g., graphical symbols, icons or photographs) on a wireless device's screen. Extensible Markup Language (“XML”) is generally a currently available standard that performs as a universal language for data, making documents more interchangeable. XML allows information to be used in a variety of formats for different devices, including PCs, PDAs and web-enabled mobile phones.

XML enables documents to be exchanged even where the documents were created and/or are generally used by different software applications. XML may effectively enable one system to translate what another systems sends. As a result of data transfer improvements, wireless device GUIs can be utilized in accordance with a hand held device and wireless network 140, whether configured as a paging network or another network type, to render images on the hand held device that closely represent the imaging capabilities available on desktop computing devices.

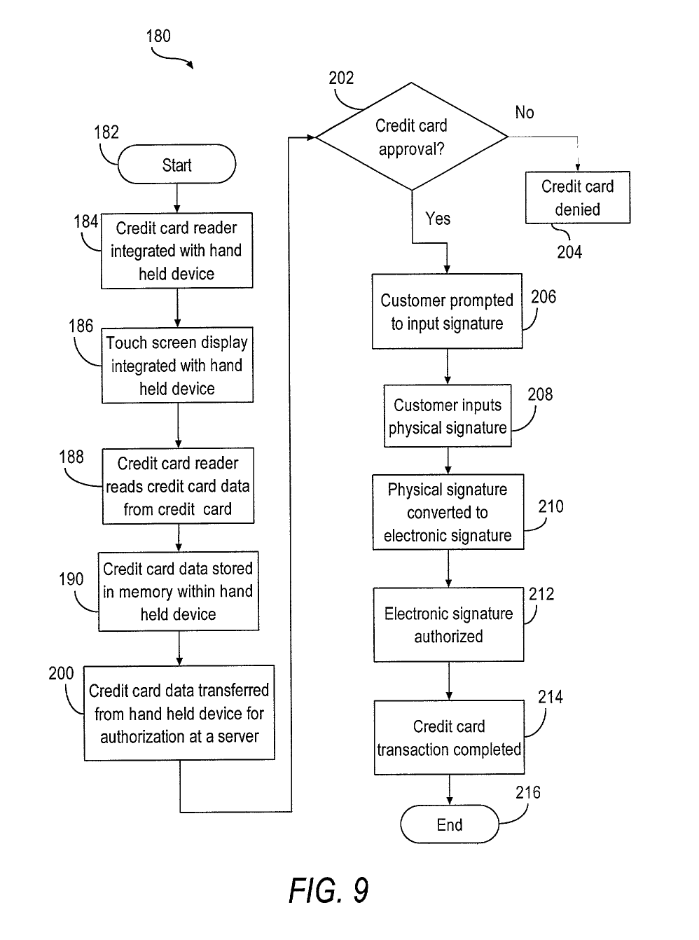

FIG. 9 depicts a flow chart 180 of operations for processing credit card transactions through a wireless hand held device, in accordance with preferred embodiments of the present invention. As illustrated at block 182, the process is initiated. As indicated at block 184 a user possesses a hand held device integrated with a credit card reader. The credit card reader may be configured with a credit card processing module, such as credit card processing module 35 indicated in FIG. 1. As indicated at block 186, the hand held device is also integrated with a touch screen display.

Credit card data may be thus read from a credit card or smart card utilizing the credit card reader integrated with the hand held device, as indicated at block 188. Credit card data may be then stored within a memory unit of the hand held device, as depicted at block 190. Thereafter, credit card data may be transferred from the hand held device for authorization at a server, as illustrated at block 200. Note that such a server may be operated within a network associated with the enterprise itself, or by the credit card company. In such a case, authorization occurs through wired means, such as a network connection from a WLAN to the credit card company server.

A decision may then be made, as indicated at block 202 to determine if credit card approval is granted. If not, then the credit card transaction is denied, as illustrated at block 204. If the credit card is approved, then as described at block 206, the customer (i.e., credit card holder) may be prompted to input a signature through the touch screen display to the hand held device. The customer inputs the physical signature, as illustrated at block 208, and thereafter, as depicted at block 210, the physical signature can be converted to an electronic signature (i.e., electronic data representative of a physical signature). Following authorization, validation and/or successful processing of the electronic signature, as indicated at block 212, the credit card transaction is then completed, as illustrated at block 214. The process then terminates, as indicated at block 216. The electronic signature and credit card data read from the credit card through the hand held device may undergo further processing, such as authentication through a server, submission to payment authorities, and recordation for accounting purposes.

The embodiments and examples set forth herein are presented in order to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A method for processing credit card data through a wireless hand held device, said method comprising the steps of:
reading credit card data from a credit card utilizing a credit card reader integrated with a wireless hand held device; and
physically permitting a credit card holder to input an electronic signature through a touch screen display integrated with said wireless hand held device to authorize a credit card transaction associated with said credit card.

2. The method of claim 1 further comprising the step of:
transferring said credit card data from said wireless hand held device to a wireless network.

3. The method of claim 1 wherein the step of physically permitting a credit card holder to input an electronic signature through a touch screen display integrated with said wireless hand held device to authorize a credit card transaction associated with said credit card, further comprising the steps of:
accepting a physical signature input via said touch screen display by a credit card holder; and
converting said physical signature to an electronic signature.

4. The method of claim 3 further comprising the steps of:
transferring said electronic signature from said wireless hand held device through a wireless network to a server.

5. The method of claim 4 further comprising the step of:
authenticating said electronic signature and said credit card data through said server; and
storing said credit card transaction at said server.

6. The method of claim 5 further comprising the step of:
rendering said electronic signature as a facsimile of a physical signature associated with said electronic signature and credit card transaction data at a printing station associated with said wireless network.

7. The method of claim 5 further comprising the step of:
rendering said electronic signature as a facsimile of a physical signature associated with said electronic signature and credit card transaction data at a printing station associated with said credit card holder.

8. The method of claim 5 further comprising the step of:
rendering credit card transaction data and said electronic signature as a digitized representation of a physical signature to an electronic mailbox associated with said credit card holder.

9. The method of claim 5 further comprising the step of:
rendering an electronic receipt in an electronic medium selected by said credit card holder, wherein said electronic receipt verifies said credit card transaction.

10. The method of claim 5 further comprising the step of:
rendering an electronic receipt in an electronic medium selected by said credit card holder, wherein, said electronic receipt verifies said credit card transaction and wherein said rendering is based on a credit card holder profile of said credit card holder.

11. The method of claim 10 further comprising the step of:
transferring said electronic receipt to a user email account associated with said credit card.

12. The method of claim 5 wherein the step of authorizing said electronic signature and said credit card data through said server, further comprises the step of:
authorizing said electronic signature and said credit card data through an authorization server associated with said wireless network.

13. The method of claim 2 further comprising the step of:
authorizing said electronic signature and said credit card data through a credit card authorization server associated with said wireless network.

14. The method of 1 further comprising the step of:
transferring an electronic record of said credit card transaction to a wireless printer from said wireless hand held device through wireless communications.

15. The method of 1 further comprising the step of:
transferring an electronic record of said credit card transaction to a wireless hand held device associated with said credit card holder through said wireless communications.

16. A system for processing credit card data through a wireless hand held device, said system comprising:
credit card reading module for reading credit card data from a credit card utilizing a credit card reader integrated with a wireless hand held device; and
electronic signature module for physically permitting a credit card holder to input an electronic signature through a touch screen display integrated with said wireless hand held device for use in authorizing a credit card transaction associated with said credit card.

17. The system of claim 16 further comprising:
wireless communications module for transferring said credit card data from said wireless hand held device to a wireless network.

18. The system of claim 16 wherein said system further comprises:
conversion module for converting a physical signature of a credit card holder to an electronic signature.

19. The system of claim 17 further comprising:
transmission module for transmitting said electronic signature from said wireless hand held device through said wireless communications module to a wireless printer.

20. The system of claim 17 further comprising:
authorization module for authorizing said electronic signature and said credit card data through a remote server.

21. The system of claim 20 further comprising:
rendering module for rendering said electronic signature as a facsimile of a physical signature of said credit card holder and credit card transaction data at a printing station associated with said wireless network.

22. The system of claim 20 further comprising:
rendering module for rendering said electronic signature as a facsimile of said physical signature and credit card transaction data at a printing station associated with said credit card holder.

23. The system of claim 20 further comprising:
rendering module for rendering said electronic signature as a digitized representation of said physical signature and credit card transaction data at an electronic mailbox associated with said credit card holder.

24. The system of claim 20 further comprising:
rendering module for rendering an electronic receipt in an electronic medium for said credit card holder, wherein said electronic receipt verifies said credit card transaction.

25. The system of claim 24 further comprising:
transfer module for transferring said electronic receipt to a user e-mail account associated with said credit card.

26. The system of claim 20 wherein said authorization module further comprises:
authorization module for remotely authorizing said electronic signature and said credit card data through a credit card authorization server associated with said credit card.

27. The system of claim 20 wherein said authorization module further comprises:
authorization module for authorizing said electronic signature and said credit card data through a credit card authorization server through said wireless network.

28. The system of 20 further comprising:
transfer module for transferring an electronic record of said credit card transaction to a wireless printer from said wireless hand held device through wireless communications.

29. The system of claim 16 further comprising:
transfer module for transferring an electronic record of said credit card transaction to a wireless hand held device associated with said credit card holder through said wireless communications.

30. A wireless hand held device for reading credit cards, comprising:
a touch screen display integrated with said wireless hand held device;
a credit card reader integrated with said wireless hand held device;
an electronic signature module for accepting and processing a physical signature input via said touch screen display by a credit card holder; and
wireless communicator integrated with said wireless hand held device that permits said wireless hand held device to communicate with a wireless network, thereby permitting an electronic signature and credit card data read from a credit card through said credit card reader to be transferred from said wireless hand held device to said wireless network.
